(19) United States
(12) Patent Application Publication
(10) Pub. No.: US 2008/0128453 A1
(43) Pub. Date: Jun. 5, 2008

(54) Dispenser security system

(75) Inventors: William H. Burckholter, Philo, OH (US); Raymond E. Kirkbride, Roseville, OH (US); Ricky R. Rose, Blue Rock, OH (US)

Correspondence Address: CALFEE HALTER & GRISWOLD, LLP, 800 SUPERIOR AVENUE, SUITE 1400, CLEVELAND, OH, 44114, US

(73) Assignee: Flint Loc Security LLC

(21) Appl. No.: 11/724,776

(22) Filed: Mar. 16, 2007

Related U.S. Application Data
(60) Provisional application No. 60/867,960, filed on Nov. 30, 2006.

(51) Int. Cl. B67D 5/12

(52) U.S. Cl. 222/75

(57) ABSTRACT

A dispenser security system includes one or more tamper detection sensors and a dispenser security controller. The dispenser security controller disables a dispensing mechanism in response to a tamper detection input from a tamper detection sensor that indicates that the dispenser is being tampered with. The dispenser security system also provides one or more alerts in response to the tamper detection input.

### CROSS-REFERENCE TO RELATED APPLICATIONS

This non-provisional application claims the benefit of U.S. Provisional Patent Application No. 60/867,960, entitled “Dispenser Security System,” filed on Nov. 30, 2006, the entire disclosure of which is incorporated herein by reference, to the extent that it is not conflicting with this application.

### BACKGROUND

Fuel theft from retail dispensers is a significant source of economic loss for fuel retailers. Current fueling facilities rely on remote monitoring of the fueling process by fuel retailer personnel and “self service” dispensing of the fuel into the vehicle, making the facilities vulnerable to theft of fuel. Often, by the time the monitoring personnel becomes aware of the theft, the thief has already left the facility and the loss has already occurred. When diesel fuel is stolen by a driver of an over-the-highway tractor, a large amount of fuel can be lost in a single theft.

Fuel is stolen from retail dispensers using many techniques. For example, doors or panels on the fuel dispenser can be opened or removed to provide access to internal metering components of the dispenser such as pulsars. The metering component can be disabled so that fuel may be pumped from the dispenser without triggering any indication of fuel flow. In other cases, the dispenser is placed in a programming mode that is normally used to change operating characteristics of the fuel dispenser. When the dispenser is in programming or stand alone mode, fuel can be pumped from the dispenser without triggering any indication of fuel flow. The dispenser may be placed in programming mode by accessing a hidden magnetically actuated reed switch with a magnet. The reed switch may be installed out of view behind a panel on which the amount of fuel that has been pumped is displayed. When the magnet is placed in proximity to the reed switch, the switch closes to signal the computer to transition to programming mode.

### SUMMARY

A dispenser security system controls one or more fuel dispensing components to prevent the flow of fuel from the dispenser if the security system detects that dispenser is being tampered with. The dispenser security system includes one or more sensors that detect and send signals indicative of tampering, a dispenser security controller that receives the tampering signals, and one or more dispenser disablement mechanisms that prevent flow of fuel from the dispenser. The dispenser security controller controls the dispenser disablement mechanisms based on inputs from the sensors. The sensors may be, for example, magnetic reed switches mounted on access panels or near a programming mode switch. When an access panel or programming mode switch is moved out of position, a trigger signal is generated by the dispenser security controller that activates the dispenser disablement mechanism. The dispenser security controller may also activate one or more alert mechanisms. The dispenser disablement mechanism may be, for example, a switch or contactor. The switch or contactor can prevent the flow of power to a control valve that allows the flow of fuel out of the dispenser or the flow of power to a pump that pumps fuel out of the dispenser.

Further features and advantages of the invention will become apparent from the following detailed description made with reference to the accompanying drawings.

### BRIEF DESCRIPTION OF THE DRAWINGS

FIG. 1 is a front view of a typical retail fuel dispenser that includes a dispenser security system constructed in accordance with an embodiment of the present invention;

FIG. 2 is a front view of the fuel dispenser of FIG. 1 with an access panel open to show internal components;

FIG. 3 is a perspective view of a dispenser security system constructed in accordance with an embodiment of the present invention;

FIG. 4 is an electrical schematic block diagram of the dispenser security system of FIG. 3;

FIGS. 5A and 5B are schematic views of a tamper detection sensor that can be used as part of the dispenser security system of FIG. 3;

FIG. 6 is a schematic view of a plurality of tamper detection sensors that can be used as part of the dispenser security system of FIG. 3;

FIG. 7 is a schematic view of a tamper detection sensor that can be used as part of the dispenser security system of FIG. 3; and

FIG. 8 is an electrical schematic view of an auxiliary relay box that can be used as part of the dispenser security system of FIG. 3.

### DESCRIPTION

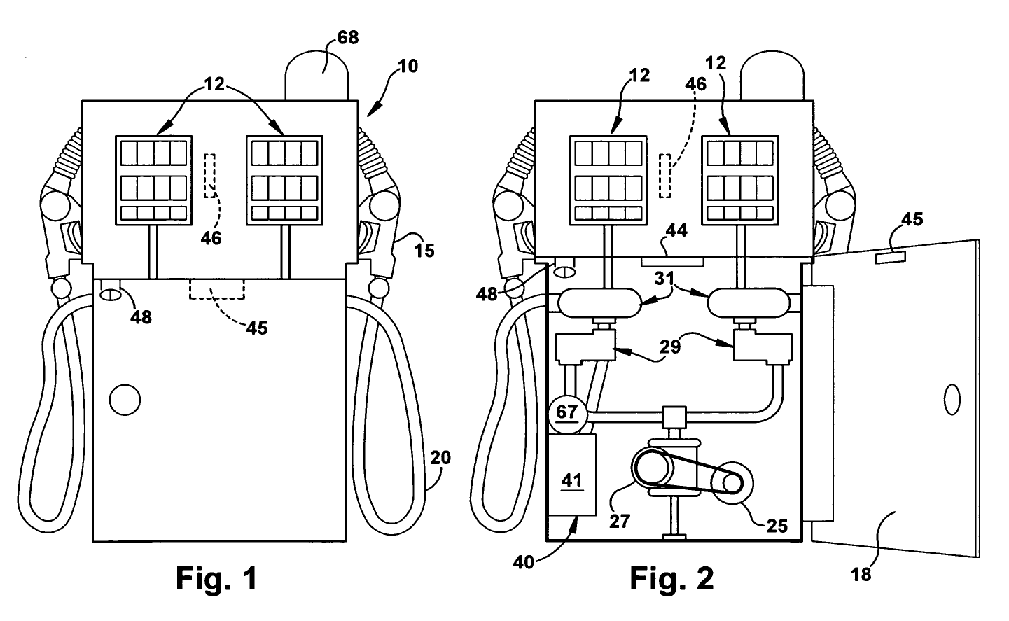

FIG. 1 depicts a typical retail fuel dispenser 10 that is used to pump fuel out of a storage tank (not shown) through a hose 20 and out of a nozzle 15. The fuel dispenser includes a top enclosure that houses a dispenser control computer (not shown) and readouts 12 that display information related to the fuel purchase. The dispenser control computer controls operation of the various dispenser components according to stored programming steps. In order to enable programming of the dispenser control computer, a programming enable switch is present on the dispenser. The programming enable switch must be actuated to place the dispenser control computer in a mode in which it can be programmed. When the control computer is in the programming or stand alone mode, fuel may be dispensed from the dispenser without activation of the control computer registering the fact that fuel is being dispensed from the dispenser. In the dispenser shown in FIG. 1, a magnetic programming key switch 48 is in electrical communication with the dispenser control computer and can be actuated to place the computer into the programming enable mode or normal operating mode. Other dispensers have a magnetically actuated programming enable switch (not shown) that is usually located behind a front dispenser panel on which the displays 12 are mounted.

FIG. 2 shows the retail fuel dispenser 10 with an access door 18 open to expose internal components of the fuel dispenser. A pump 27, which in this case is driven by a motor 25, draws fuel from the storage tank. The fuel flows from the pump 27 to one or more control valves 29 that control the rate of flow of fuel to the hose 20. Usually, each dispenser hose 20 has a dedicated control valve. A pulsar 31 electronically monitors a volume of fuel that is flowing from the valve to the hose. The pulsar 31 is in signal communication with the dispenser control computer and provides signals indicative of the volume of fuel flow to the dispenser control computer. The control computer displays an amount of fuel being dispensed on the dispenser displays 12.

In most modern retail fuel establishments, the amount of fuel being dispensed by each dispenser is also communicated to a central control panel (not shown) located, for example, at a cashier station. The central console panel is used by the cashier to enable operation of the pump when dispensing is approved or disable operation of the pump when dispensing has not been approved. In many instances, the cashier is the sole means of preventing unauthorized dispensing of fuel. Many thieves disable the pulsar 31 or activate the programming enable switch so that the dispensing of fuel is not communicated to the central console panel, making it difficult for a cashier to realize that fuel is being stolen, especially in retail fuel establishments that have multiple dispensers.

For the purposes of this description, the fuel dispenser components shown in FIGS. 1 and 2 are intended as examples of fuel dispenser components. It will be apparent to one of skill in the art that other fuel dispenser configurations and components can be used in various implementations of the dispenser security system. For example, the control valve and pump may be housed within the same housing. The pump may be located within the storage tank. The upper enclosure may have various configurations as well as the display 12.

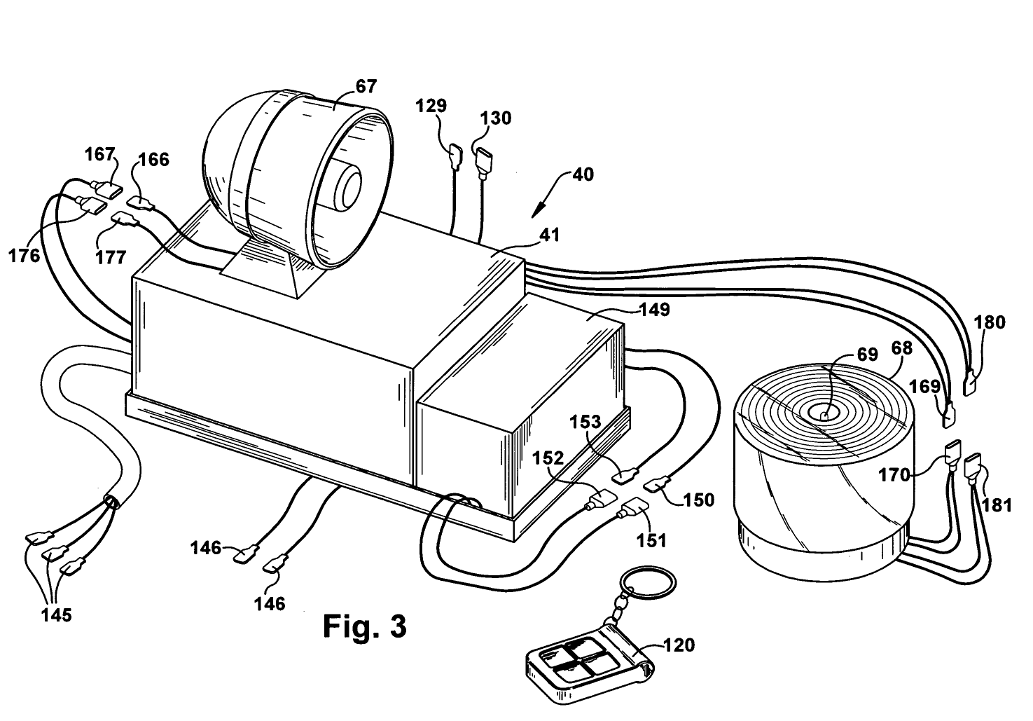

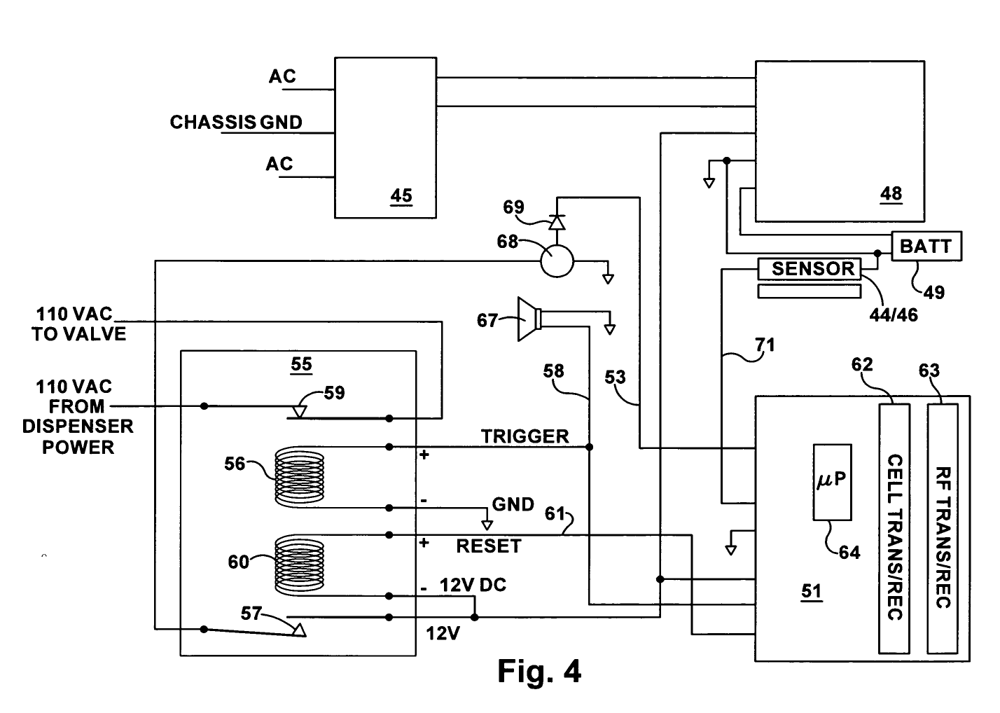

A dispenser security system 40 is shown installed within the fuel dispenser 10 in FIG. 2. The dispenser security system includes an alarm unit 41, a siren 67, a strobe light 68, and an arming status indicator LED 69 (FIGS. 3 and 4). The alarm unit is electrically connected in series with a low speed power lead to the control valve 29 (FIG. 2) as will be described in more detail below. While the connections are not shown in FIGS. 1 and 2, the alarm unit 41 is also connected to various tamper detection sensors such as a magnetic reed switch 44 mounted in the dispenser that has an associated magnet 45 mounted on a sensor access panel or door 18. When the door is closed and the magnet 45 is placed in proximity to the reed switch 44, the magnet 45 maintains the reed switch in an open, or non-conducting, position. When the door is opened, the reed switch closes in the absence of the magnet and thereby provides a tamper detection input to the alarm unit 41. In some embodiments the alarm unit 41 is connected to a programming enable actuation detection reed switch 46 that closes when a magnet is used actuate a magnetic programming enable switch to place the dispenser control computer in programming mode.

The reed switches and key switch provide tamper detection inputs to the alarm unit 41 that indicate that the dispenser is being tampered with, such as, for example, a door or panel being opened to access a dispenser metering component or the programming reed or key switch being actuated. When the tamper detection sensors are switches that are configured in a normally open condition as described herein, they can be wired in parallel and tied together to create a single alarm tamper detection input that is turned on when any of the switches closes.

Referring now to FIG. 3, the dispenser security system 40 includes the alarm unit 41, the siren 67, the strobe light 68 with the arming status indicator LED 69, and remote controller 120. To facilitate installation of the alarm unit in a variety of dispenser configurations, the alarm unit is provided pre-wired with crimp-on connectors and with mating connectors that can be crimped to dispenser wires that are connected to the alarm unit. In this manner, the length of the wires can be selected at the installation site and the installation can be performed with standard wiring tools. An alarm unit AC power cord is provided with three AC connectors 145 that are connected to mating connectors that can be connected to AC power wires from the dispenser. The siren is connected to the alarm unit with connectors 166, 167, 176, 177. The strobe light and LED are connected to the alarm unit 41 with connectors 169, 170, and 180,181. Connections between a back up battery housed within a battery enclosure 149 and an internal power supply are made on site with connectors 150, 151, 152, 153. One or more connectors 146 are provided to connect to whatever tamper detection sensors are used with the system. For each dispenser being protected with the dispenser security system, a pair of valve leads 129, 130 are provided. To install the dispenser security system a power lead to the control valve 29 (FIG. 2), such as, for example, a low speed valve power lead, is cut or tapped into and the alarm unit is spliced into series with the power lead so that the control valve is powered through the alarm unit 41. Because the control valve 29 must be powered for fuel to be dispensed from the dispenser 10, if the alarm unit 41 cuts power to the control valve, fuel cannot be dispensed. The use of mating crimp-on connectors to splice the alarm unit into the valve power lead is advantageous because it allows the alarm unit to be disconnected from the valve power lead and the connectors on the control valve power lead to be connected to one another so that the alarm unit can be decoupled from the dispenser easily.

FIG. 4 outlines, in electrical schematic form, various dispenser security system components. The alarm unit includes an AC transformer 45 that steps 110 Volts AC from a standard electrical outlet down to 16 Volts AC. A power supply 48 converts the 16 Volts AC to 12 Volts DC. An optional back-up battery 49 is connected to the power supply 48 so that it can be recharged by the power supply. The back-up battery is also connected as a power source for the magnetic reed sensors 44, and/or the programming enable key switch 46 and other electrical components in the alarm unit 40.

Housed within the alarm unit 40 is a dispenser security controller 51. The dispenser security controller includes a microprocessor 64 that evaluates tamper detection inputs from the various tamper detection sensors 44, 46, 48, and arming/disarming inputs from an RF receiver 63, and an optional cellular phone signal receiver/transmitter 62. The dispenser security controller 51 controls operation of a valve and strobe light control relay 55, the siren 67, and the arming indicator LED 68 in response to an alarm signal from the microprocessor. Optionally, the cellular phone signal receiver/transmitter 62 may also include an auto-dialer not shown that dials one or more predetermined phone numbers to deliver an alert message by phone.

The microprocessor 64 can operate in an armed mode in which a tamper detection input causes an alarm signal be output. When the microprocessor is in the armed condition, the dispenser security controller 51 outputs power to light the arming status indictor LED 69. The microprocessor can be switched between the armed mode and a disarmed mode with the remote controller 120 (FIG. 3) that transmits an arming or disarming radio frequency signal that is received by the RF receiver 63 in the dispenser security controller 51. Optionally the microprocessor can be switched between the armed mode and disarmed mode with signals that are transmitted by cell phone to the cellular transmitter/receiver 62.

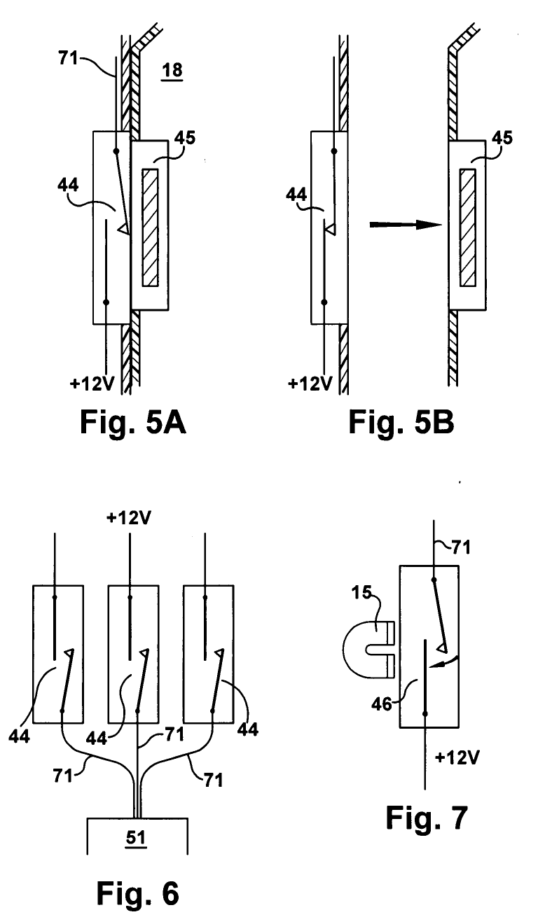

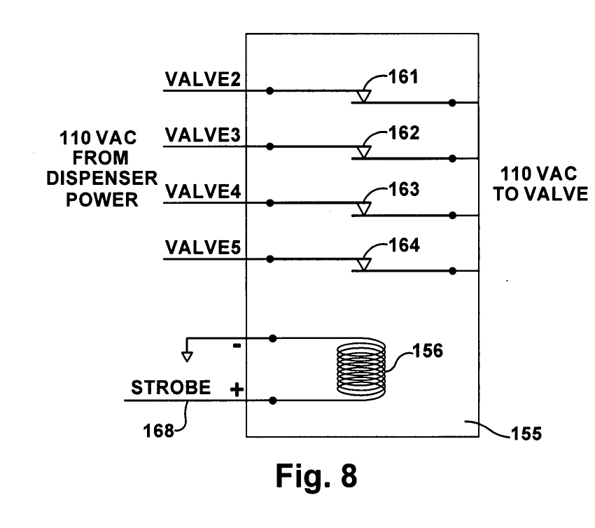

The magnetic reed switches 44/46, that are used to indicate that the dispenser is being tampered with are connected to the power supply 48 and battery 49. When one of the reed sensor switches is closed due to tampering, the switch connects the power supply and battery to the dispenser security controller 51 to provide a tamper detection input to the dispenser security controller on a tamper detection input line 71. FIG. 5A shows a magnetic reed switch 44 mounted on the dispenser. The magnetic reed switch is connected at one end to 12 Volts from the power supply and battery and at the other end to the tamper detection input line 71. The magnetic reed switch is being held open by a magnet 45 that is mounted on the dispenser access panel 18. When the access panel is moved away from the dispenser as shown in FIG. 5B, the magnetic reed switch closes to provide a closed circuit between the power supply and battery to the dispenser security controller on input line 71. FIG. 6 shows a number of magnetic reed switches 44 connected in parallel between the power supply and battery 12 Volts and the dispenser security controller 51. As can be seen from the diagram, if any of the magnetic reed switches is closed, a closed circuit is created between 12 Volts and the dispenser security controller on input line 71.

As discussed in the background, thieves may attempt to place the dispenser's computer in programming mode so that fuel can be dispensed without console knowledge. In some embodiments, a programming switch sensor that senses operation of the programming enable switch is connected to dispenser security controller to provide a tamper detection input when the programming switch is actuated. Operation of the programming switch can be detected by the magnetic reed switch 46. FIG. 7 shows a normally open magnetic reed switch 46 that is placed in proximity to a magnetically actuable programming enable switch such as the programming enable switch 48 or a programming enable switch that is hidden behind the dispenser's display panel as shown in FIG. 1. When a magnet 15 is placed in proximity to the magnetic reed switch 46 during an attempt to place the dispenser control computer in the programming mode, the magnet reed switch 46 closes as indicated by the arrow to create a closed circuit between 12 Volts from the power supply and battery on the input line 71.

Returning to FIG. 4, when the microprocessor 64 has been placed in the armed mode, a closed circuit condition of any of the tamper detection sensors provides a tamper detection input to the dispenser security controller. In response to the tamper detection input, the microprocessor outputs an alarm signal that causes the dispenser security controller to transmit a trigger signal that disables the control valve to prevent dispensing of fuel. The dispenser security controller also activates visible and audible alerts such as the flashing strobe light 68 and siren 67. To disable the control valve and provide the alerts, the dispenser security controller 51 operates a latching double pole double throw control valve and strobe light control relay 55 that controls the flow of power to the control valve 29 and strobe light 68.

The control relay 51 includes a pair of mechanically latching contact sets: a normally closed contact set 59 that is located in the power flow path of the control valve and a normally open contact set 57 that is in the power flow path of the strobe light 68. A trigger coil 56 can be energized by the trigger signal 58. When the trigger signal energizes the trigger coil, the normally closed contact set 59 is forced open, cutting power to the control valve and disabling the dispenser. In addition, energization of the trigger coil forces the normally open contact set 57 closed to connect 12 Volts to the strobe light and cause it to flash. Due to the latching feature of the contact sets, the contact sets 56, 60 maintain their triggered position after the trigger coil is de-energized. A reset coil 60 is connected to a reset signal 61 on the dispenser security controller that opens a path to ground for the reset coil through the dispenser security controller. When the reset coil is energized, the contact sets are forced back to their normal conditions and will maintain those conditions after the reset coil is de-energized. In this manner, in response to the trigger signal 58 from the dispenser security controller 51, the control relay 55 disables the control valve and powers the alert strobe until a reset signal 61 is received from the dispenser security controller 51. This reset signal can be provided in response to, for example, an RF signal from the remote control 120 (FIG. 3).

In addition to triggering the valve and strobe light control relay, the dispenser security controller 51 also provides outputs to control the siren 67 and the arming status indicator LED 69. When the dispenser security controller provides the trigger signal in response to a tamper detection input, the trigger signal provides power to sound the siren 67 for a predetermined length of time. An additional timer (not shown) may be included to provide a relatively accessible way to control the amount of time the siren is sounded. The dispenser security controller also includes an LED output 53 that causes the arming status indicator LED 69 to flash in a pattern corresponding to which tamper detection sensor triggered the alarm. For example, if a door sensor triggered the alarm, the LED will flash in groups of three flashes and if the programming switch triggered the alarm, the LED will flash in groups of four flashes. When the microprocessor is in the armed mode, the arming indicator LED 69 is continuously flashing.

As discussed above, the microprocessor changes between the armed mode and disarmed mode in response to RF signals from the remote controller 120 that is capable of sending an arming signal, a disarming signal, and a reset signal. The specific frequency of the signals periodically changes to a different randomly selected signal. The method of selecting frequencies is synchronized between the RF receiver 63 and the remote controller 120 to protect against unauthorized signals communicating with the microprocessor to disarm or reset the alarm unit. In addition to controlling the relay 55, the siren 67, and LED 69, the dispenser security controller 51 may also provide an RF frequency output from the RF receiver/transmitter 63 to a remote receiver. The dispenser security controller may include a cellular phone signal receiver/transmitter 62 that is capable of sending and receiving cellular phone transmissions to arm, disarm, and reset the dispenser security controller. Optionally, the cellular phone signal receiver/transmitter 62 may include an auto-dialer that dials one or more predetermined phone numbers, such as to a monitoring service, to provide tampering alerts by phone to a remote operator. Because of the harsh environmental conditions associated with installation in a retail fuel dispenser, in some embodiments, the dispenser security controller 51 and its components are capable of functioning reliably in extreme temperature and humidity conditions. In addition, a “panic” feature may be included in which the alarm may be triggered by pressing a panic button on the remote controller 120. The microprocessor 64 treats the panic input as a tamper detection input.

Figure shows an auxiliary relay box 155 that can expand the control capabilities of a single alarm unit to disable multiple control valves simultaneously. Power lines for four additional control valve 2-5 are spliced to each include in its electrical path a non-latching, normally closed contact set 161, 162, 163, 164. An auxiliary relay coil 156 is connected to the output of the normally open contact set 57 (FIG. 4) that provides power to the strobe 68. During normal operation, the contact sets 161, 162, 163, 164 are in their normal closed condition and the control valves are operational. In the event that tampering is detected, when the normally open contact set 57 is closed to provide power to the strobe light, the auxiliary relay coil 156 is also energized, forcing the contact sets 161, 162, 163, 164 open to disable control valves 2-5. Due to the latching feature of the contact set 57, the auxiliary coil 156 will remain energized until a reset signal 61 is received by the microprocessor.

While various aspects of the invention are described and illustrated herein as embodied in combination in the exemplary embodiments, these various aspects may be realized in many alternative embodiments not shown, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however; such values and ranges are not to be construed in a limiting sense and are intended to be critical values or ranges only if so expressly stated.

We claim:

1. A dispenser security system for use with a dispenser that includes a dispensing mechanism that controls the dispensing of fluid from the dispenser, the dispenser security system comprising:
one or more tamper detection sensors mounted on the dispenser, the tamper detection sensors being adapted to detect operation of one or more dispenser components;
a dispenser security controller in signal communication with the one or more tamper detection sensors that receives one or more tamper detection inputs and is configured to generate a trigger signal in response to the one or more tamper detection inputs; and
one or more dispenser disablement mechanisms in signal communication with the dispenser security controller and the dispensing mechanism, the one or more dispenser disablement mechanisms adapted to disable operation of the dispensing mechanism in response to a trigger signal from the dispenser security controller to prevent dispensing of fluid from the dispenser.

2. The dispenser security system of claim 1 wherein the one or more tamper detection sensors comprise a magnetic reed switch that is held in a first position when a magnet is in proximity to the reed switch and moves to a second position when the magnet is not within proximity to the reed switch and wherein the reed switch is connected between a voltage source and the dispenser security controller.

3. The dispenser security system of claim 2 wherein the first position is an open position in which the dispenser security controller is not in electrical communication with the voltage source and wherein the second position is a closed position in which the dispenser security controller is in electrical communication with the voltage source.

4. The dispenser security system of claim 3 further comprising a magnet switch component that is mounted on a dispenser access panel in proximity to a corresponding magnetic reed switch to maintain the magnetic reed switch in the first position when the dispenser access panel is in a dispenser closed position.

5. The dispenser security system of claim 3 wherein the magnetic reed switch is mounted in proximity to a magnetic dispenser programming enable switch such that when a magnet is placed in proximity to the magnetic dispenser programming enable switch, the magnet reed switch is moved by the magnet to the second position to provide a tamper detection input to the dispenser security controller.

6. The dispenser security system of claim 1 wherein the tamper detection sensor is a switch that places a voltage source in signal communication with the dispenser security controller upon movement of a dispenser programming enable switch to a programming enable position to provide a tamper detection input to the dispenser security controller.

7. The dispenser security system of claim 1 wherein the dispenser disablement mechanism is a valve switch mechanism controlled by the dispenser security controller and wherein the dispensing mechanism comprises a dispenser control valve that must be actuated to allow fluid to be dispensed from the dispenser.

8. The dispenser security system of claim 7 wherein the dispenser control valve is actuated by supplying a voltage to the dispenser control valve and wherein the valve switch mechanism is a valve control relay that is placed in within a voltage supply path to the dispenser control valve.

9. The dispenser security system of claim 1 wherein the dispenser disablement mechanism is a pump switch mechanism controlled by the dispenser security controller and wherein the dispenser mechanism comprises a dispenser pump that must be actuated to cause fluid to be dispensed from the dispenser.

10. The dispenser security system of claim 9 wherein the dispenser pump is actuated by supplying a voltage to the dispenser pump and wherein the pump switch mechanism is a pump control relay that is placed in within a voltage supply path to the dispenser pump.

11. The dispenser security system of claim 1 comprising one or more alert mechanisms in signal communication with the dispenser security controller to provide a perceptible indication that tampering has been detected by a tamper detection sensor.

12. The dispenser security system of claim 11 wherein the alert mechanism comprises an audible siren.

13. The dispenser security system of claim 11 wherein the alert mechanism comprises a strobe light.

14. The dispenser security system of claim 11 wherein the alert mechanism comprises a light emitting diode.

15. The dispenser security system of claim 11 wherein the alert mechanism comprises a radio transmitter adapted to broadcast an alert radio signal.

16. The dispenser security system of claim 11 wherein the alert mechanism comprises an auto-dialer device adapted to transmit an alert message to a preprogrammed telephone number.

17. The dispenser security system of claim 1 wherein the dispenser includes a plurality of independently operable dispensing mechanisms and a corresponding number dispenser disablement mechanisms.

18. The dispenser security system of claim 1 wherein the dispenser security controller includes a radio frequency receiver adapted to receive a radio frequency arming signal that places the dispenser security controller in an armed mode in which the dispenser security controller generates a trigger signal in response to a tamper detection input and a radio frequency disarming signal that places the dispenser security controller in a disarmed mode in which the dispenser security controller does not generate a trigger signal in response to a tamper detection input.

19. A method that disables dispensing of fluid from a dispenser, wherein the dispenser includes a dispensing mechanism that controls dispensing of fluid from the dispenser comprising:
mounting one or more tamper detection sensors in proximity to a corresponding one or more dispenser components, wherein each of the tamper detection sensors provides a tamper detection input when operation of the corresponding one or more dispenser components is detected;
receiving the tamper detection input from the one or more tamper detection sensors; and
in response to the tamper detection input, disabling the dispensing mechanism to prevent the dispensing of fluid from the dispenser.

20. The method of claim 19 wherein the step of mounting one or more tamper detection signals is performed by mounting a magnetic reed switch on a first dispenser component.

21. The method of claim 20 further comprising the step of mounting a magnet on a second dispenser component proximate to the first dispenser component such that the magnet acts upon the magnetic reed switch to maintain the reed switch in a first position and wherein movement of the magnet away from the magnetic reed switch causes the magnetic reed switch to transmit the tamper detection signal.

22. The method of claim 21 wherein the first dispenser component is a dispenser access panel mounting surface and the second dispenser component is dispenser access panel.

23. The method of claim 19 wherein the step of mounting one or more tamper detection signals is performed by mounting a magnetic reed switch in proximity to a magnetically actuated dispenser programming enable switch.

24. The method of claim 19 wherein the step of disabling the dispensing mechanism is performed by disconnecting power from a dispenser control valve that enables the dispensing of fluid from the dispenser.

25. The method of claim 19 wherein the step of disabling the dispensing mechanism is performed by disconnecting power from a pump that pumps fluid from the dispenser to dispense fluid from the dispenser.

26. The method of claim 19 comprising the step of providing an alert notification when the tamper detection signal is received.

27. The method of claim 26 wherein the step of providing an alert notification is performed by activating an audible siren.

28. The method of claim 27 comprising the step of de-activating the siren after a predetermined amount of time.

29. The method of claim 26 wherein the step of providing an alert notification is performed by activating a strobe light.

30. The method of claim 26 wherein the step of providing an alert notification is performed by transmitting an alert message to a phone number.

31. The method of claim 26 wherein the step of providing an alert notification is performed by transmitting a radio frequency alert message.

32. The method of claim 19 comprising the step of receiving a security system arming signal from an arming device to enter an armed condition and wherein the step of disabling the dispensing mechanism is performed only during the armed condition.

33. The method of claim 32 wherein the step of receiving a security system arming signal is performed by receiving a radio signal on a predetermined radio frequency.

34. The method of claim 19 comprising the step of receiving a security system disarming signal to enter a disarmed condition and wherein the step of disabling the dispensing mechanism is not performed during the disarmed condition.

35. The method of claim 19 comprising receiving a panic input from a remote transmitter and disabling the dispensing mechanism in response to the panic input.
